(19) United States
(12) Patent Application Publication
(10) Pub. No.: US 2014/0229296 A1
(43) Pub. Date: Aug. 14, 2014

(54) SYSTEM AND METHOD FOR EXTRACTING STYLE INFORMATION FROM WEB PAGES AND GENERATING ADVERTISEMENTS

(71) Applicant: Google Inc., (US)

(72) Inventors: Kai Ye, Shanghai (CN); Yongtai Zhu, Shanghai (CN); Zuo Yan, Seattle, WA (US); Guannan Zhang, Shanghai (CN)

(73) Assignee: Google Inc., Mountain View, CA (US)

(21) Appl. No.: 13/765,048

(22) Filed: Feb. 12, 2013

(51) Int. Cl. G06Q 30/02

(52) U.S. Cl. CPC G06Q 30/0276
USPC 705/14.72

(57) ABSTRACT

Apparatus and method for generating advertisements for an advertiser based upon style information contained in the advertiser's web pages. An ad generation system is used to analyze and extract style information from the advertiser's web pages. The style information can then be incorporated into an advertisement template to generate the advertisement for the advertiser.

### BACKGROUND

Content providers, such as publishers, generally operate to provide content for display on web pages of Internet websites or via mobile applications. The content is typically accompanied by advertisements which link to other content providers. Advertisements can take considerable time and creation effort to generate.

Accordingly, there is a need for a system whereby content providers can quickly and efficiently have advertisements generated that promote their products and are coordinated with their web pages and/or brands.

### SUMMARY

Various embodiments disclosed herein are generally directed to an apparatus and method for managing user selected content displayed along with publisher content on publisher's web pages.

In accordance with some embodiments, a computer-implemented method comprises analyzing at least one web page to determine style information of the at least one web page. Once the at least one web page has been analyzed, the style information is extracted from the at least one web page. An advertisement is then created based upon the style information extracted from the at least one web page.

In accordance with the disclosure, an apparatus includes a memory for storing an advertiser's web page. The apparatus also includes an ad generation system to analyze an advertiser's web page, extract style information from the web page and generate an advertisement based upon the style information extracted from the web page. The apparatus can also include a second memory for storing the advertisements.

In another embodiment, a computer-readable data storage medium on which is stored programming instructions adapted for execution by one or more processors. The medium is adapted to analyze at least one web page to determine style information of the at least one web page. The medium is also adapted to extract style information from the at least one web page. Finally, the stored programming of the medium can be adapted to generate an advertisement based upon the style information extracted from the at least one web page.

These and other features and advantages which may characterize various embodiments can be understood in view of the following detailed discussion and the accompanying drawings.

### BRIEF DESCRIPTION OF THE DRAWINGS

FIG. 1 provides a functional block representation of a network-based system in accordance with various embodiments.

FIG. 2 provides another functional block representation of the network-based system in accordance with various embodiments.

FIG. 3 is a flow chart that summarizes steps that may be carried out in accordance with various embodiments.

### DETAILED DESCRIPTION

The present disclosure generally relates to a system and method for generating advertisements for advertisers or content providers based on style information from the publisher's or content provider's web page. The advertisements are generated to be displayed on a user network accessible device.

Content displays of Internet web pages or mobile applications have a defined layout of all the content that is displayed when a user views the web page or mobile application on a network accessible device. The defined layout can include publisher content and at least one slot that is adapted to display an advertisement. Advertisements include an interactive portion that user selection (a “click”) of the advertisement will connect the user to a linked web page with additional information, often referred to as a “landing page.”

Companies and/or advertisers (website and/or web page publishers) spend lots of time, money and energy developing their websites and/or landing pages to promote their products or brands. These companies' websites and/or landing pages include lots of useful style information. Style information can include, but is not limited to, images, colors, color combinations, font of text, size of text, border roundness, line-wrap and the like.

The creation of advertisements to be displayed along with publisher content on a network accessible device can be an expensive and time consuming process. The style information from an advertiser's website and/or web page can be extracted and used to generate at least one advertisement for the publisher who owns the web page. The advertisements generated can then be implemented in the at least one slot of the content display of a publisher's Internet web page.

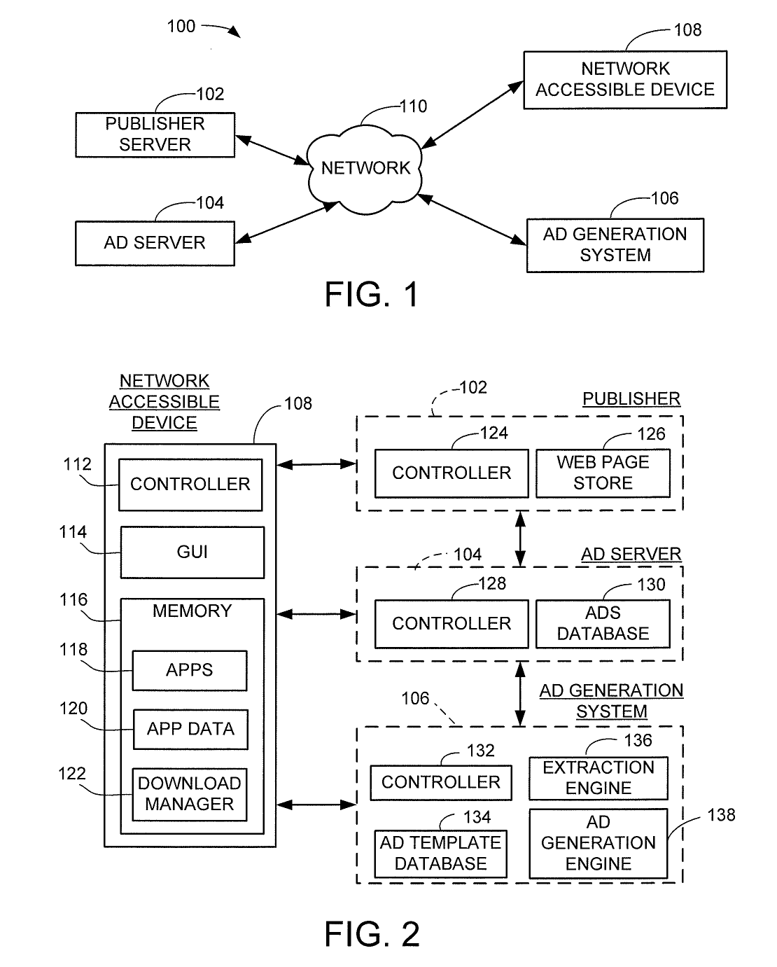

These and other features and benefits can be understood beginning with a review of FIG. 1 which depicts a network-based, user selected content transfer system 100 constructed and operated in accordance with various embodiments.

The system 100 incorporates a number of active elements including a publisher server 102, an advertisement (ad) server 104, an ad generation system 106, and at least one user network accessible device 108, all of which communicate over one or more networks 110.

The publisher server 102 may represent a web page hosting server or similar system adapted to display one or more web pages from a website of a publisher/advertiser (e.g., source of the website). The ad server 104 services ad requests to display ads in conjunction with the web pages. The ad generation system 106 searches and analyzes web pages of publishers, extracts style information from the web pages and generates various advertisements for the publisher based upon the style information included in the publisher's web page(s). The advertisements generated can then be displayed with publisher content on the user device 108.

The user devices 108 represent individual network accessible devices, such as desktop computers, laptop computers, smart phones, tablets, gaming consoles, televisions, and similar devices adapted to interact with the publisher and ad servers 102 and 104.

The network 110 can take any suitable form(s) such as a wide area network (WAN), a local area network (LAN), a broadband wireless network, etc. It will be appreciated that other elements may be incorporated into the system 100, as desired.

FIG. 2 shows aspects of the system 100 of FIG. 1 in accordance with some embodiments. A selected network accessible (user) device 108 from FIG. 1 is contemplated as comprising a desktop computer (personal computer, PC) with a high speed Internet connection to communicate with the network 110. This is merely for purposes of providing a concrete example and is not limiting.

The user device 108 includes a controller 112, a graphical user interface (GUI) 114 and memory 116. The controller 112 may be a programmable processor that uses associated operating system programming and application software (e.g., a web browser) in the memory to interact with the network 110. The GUI 114 may include a display monitor, keyboard, mouse, etc. The memory 116 may represent a hierarchical memory structure made up of various memory devices within the user device 108, including such elements as a non-volatile main memory (e.g., disc memory, solid-state drive, etc.), data transfer buffer, local processor (L1-L3) cache, etc. The memory 116 stores various operational modules including applications (apps) 118, application (app) data 120 and a download manager 122.

The ad generation system 106 requests a selected web page from the publisher/advertiser for which an advertisement will be generated. A controller 124 of the publisher server 102 processes the request to deliver content for the selected web page from a web page store 126. The ad server 104 includes a controller 128 and an ads database 130 for storing ads generated by the ad generation system 106.

The ad generation system 106 includes a controller 132, an ads template database 134, an extraction engine 136, and an ad generation engine 138. The ads template database 134 can store numerous advertisement templates for use with the style information extracted from advertisers' web pages to create advertisements for those advertisers. The extraction engine 136 analyzes web pages and extracts the style information therefrom. The ad generation engine 138 processes the style information and generates the advertisements that incorporate the style information extracted from the advertisers' web pages.

In addition to the style information, an advertiser's web page can contain advertiser's content and non-relevant information (e.g. third party contents). One example of non-relevant information includes, but is not limited to, on-page ads from another advertiser. The non-relevant information is disposed in non-relevant areas of the advertisers' web pages.

There are numerous ways in which style information contained in an advertiser's web page can be analyzed and extracted. It should be understood that any manner known in the art in which the style information can be analyzed or extracted is acceptable. In one embodiment, the extraction engine 136 renders the advertisers' web page to generate a document object model (DOM) tree with runtime style and a website snapshot. In another embodiment, the advertisers' web pages can be analyzed using cascading style sheeting (CSS).

The extraction engine 136 can parse the DOM tree to identify on-page ads and other non-relevant areas disposed on the advertisers' web pages. In another embodiment, the non-relevant areas are filtered out of the website snapshot by the extraction engine 136 so that only the advertisers' style information is extracted from the advertisers' web pages and not a third party's content.

Advertisers' web pages incorporate various colors for different parts of the web page design. Some of these colors are more dominant than other colors. In another embodiment of the disclosure, the extraction engine 136 determines the dominant colors and the dominant colors weight associated with the advertisers' web pages and extracts those dominant colors for use in an advertisement for the advertiser. The implementation of cluster analysis is one method of determining the dominant colors of a web page. It should be understood that any means known in the art for determining the dominant colors of a web page can be implemented.

The dominant colors extracted from the advertisers' web page can be used as the colors for various parts of the advertisements generated by the ad generation engine 138 of the ad generation system 106. The various parts of the advertisement that require color can include, but is not limited to, the background colors, button color, headline text color of the advertisement, advertisement descriptions color, text color of the button, and the like. In one embodiment, the colors extracted from the advertiser's web pages are weighted. A predetermined weight can be established and any color extracted from the advertiser's web page greater than the predetermined weight can be selected as the background color of the advertisement. In another embodiment, the ad generation engine 138 of the ad generation system 106 uses the most dominant color (i.e. heaviest weighted) as the advertisement background. The color extracted from the advertisers' web page with the highest saturation weight can be used as the button color. In another embodiment, the button color chosen can be evaluated based upon that color's contrast to the selected background color for the generated advertisement.

The colors extracted with high contrast and brightness difference from the color extracted and used as the background color for the advertisement can be implemented in the advertisement as the text colors. In one embodiment, colors extracted with contrast and brightness differences above a predetermined contrast and brightness difference value with respect to the selected background color for the advertisement being generated can be used as the colors for the advertisement content text. In another embodiment, a predetermined color saturation level can be established and the extracted colors with a color saturation greater than the predetermined color saturation level and a contrast and brightness difference greater than the predetermined contrast and brightness difference value can be used for headline text color for the advertisement. In a further embodiment, the extracted color with the highest saturation level can be the headline text color. In yet another embodiment, the extracted colors with a color saturation lower than the predetermined color saturation level and a contrast and brightness difference greater than the predetermined contrast and brightness difference value can be used for description text color for the advertisement. In a further embodiment, the extracted color with the lowest saturation level can be the headline text color.

Similarly, the dominant color extracted from the advertisers' web page with the highest contrast and brightness difference with respect to the extracted dominant color used for the button color can be used for the button color text. It should be understood and appreciated that any color extracted from an advertiser's web page can be used for any part of the advertisement generated for the advertiser. Furthermore, any means known in the art for selecting colors from a set of candidates can be implemented. If there are not enough colors extracted or the color scheme is not aesthetically pleasing, colors can be calculated to complete the color scheme for the generated advertisement.

In a further embodiment, the extraction engine 136 can determine the various fonts used on the advertisers' web pages. Text on an advertiser's web page can be present in numerous different font styles. In one embodiment, the fonts used on the advertisers' web pages can be grouped into a large font group and a small font group. The large font group and the small font group can be split at a specific size font. For example, the large font group can be any font for text on the advertiser's web page with a font size greater than 20. Once the font is extracted, the ad generation system 106 can determine the frequency with which each font on the advertisers' web pages is used. In one embodiment, the extraction engine 136 determines the font with the highest frequency of use in the large font group and the small font group on the advertisers' web pages. The font used with the highest frequency in the large font group can then be used by the ad generation engine 138 to be the font used for the headline of the generated advertisement. Conversely, the font used with the highest frequency in the small font group on the advertisers' web pages can then be used by the ad generation engine 138 to be the font of the description of the advertisement and/or the button text. It should be understood and appreciated that any font extracted from the advertisers' web pages can be used in the generated advertisement.

The size of the font used for the generated advertisement can vary depending on design parameters of the advertisement templates selected from the ads template database 134 for the generated advertisements. For example, the text size used for the button will vary depending on the size of the button and the amount of text to use thereon. Additionally, the text used for the advertisement description/content portion will vary depending on the size of the advertisement and the amount of text used for the description/content portion of the advertisement generated. The size of the font used for the headline can also vary depending on the size of space in the advertisement allotted to the headline and the amount of text used for the headline.

The generated advertisement can be optimized by the ad generation system 106. One example of an optimization of the advertisement is to take two or more of the dominant colors extracted from the advertisers' web pages by the extraction engine 136 of the ad generation system 106 and provide a background using a gradient of these two or more dominant colors. Another example of optimization of the generated advertisement would be to flash the button of the advertisement.

It should be understood that the ad generation system 106 can generate multiple advertisements using the style information extracted from the advertisers' web pages. The style information used for the advertisement can be varied. Additionally, various advertisement templates having numerous different layouts can be used and incorporated with the style information extracted from the advertisers' web pages.

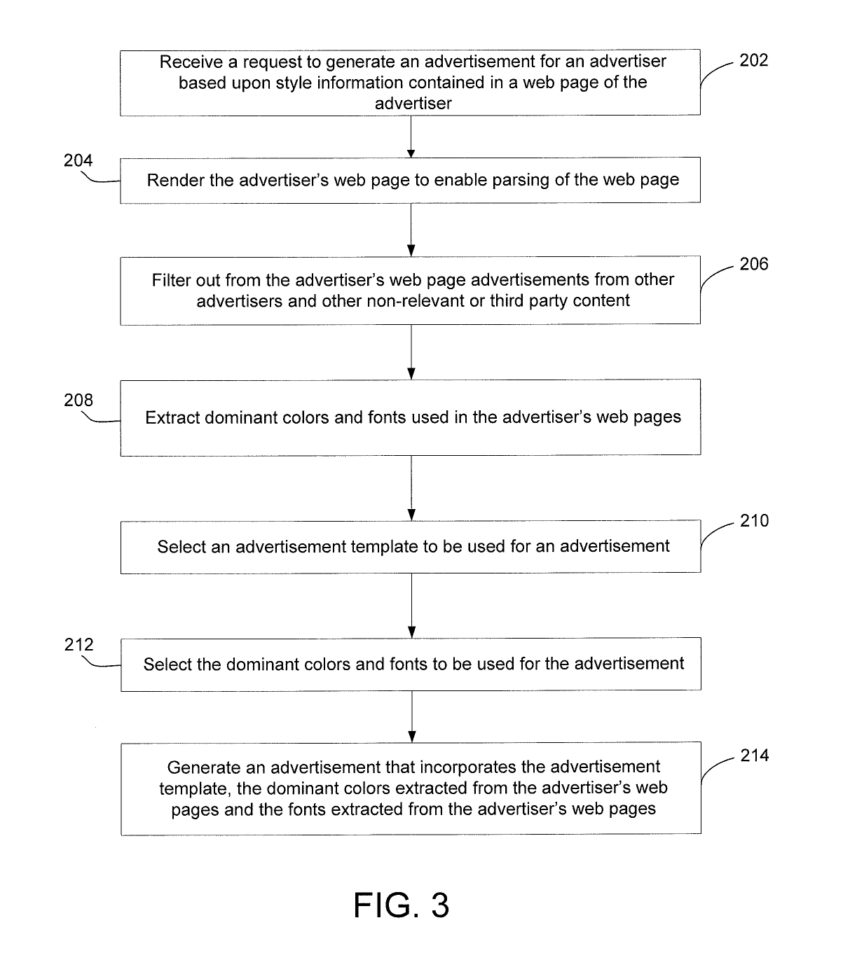

FIG. 3 illustrates a general flow chart of steps that may be carried out in accordance with this disclosure. First, the ad generation system 106 receives a request to generate an advertisement for an advertiser based upon the style information contained in the advertisers' web pages 202. In step 204, the advertiser's web page is rendered to enable the web page to be parsed. The rendered web page can then be filtered to remove advertisements from other advertisers and other non-relevant or third party content 206. Once the advertiser's web page is filtered, the dominant colors and fonts used in the advertisers' web pages are extracted 208. At steps 210 and 212, an advertisement template is selected along with the dominant colors and fonts to be incorporated into the advertisement. Finally, an advertisement is generated that incorporates the selected dominant colors and fonts extracted from the advertisers' web pages 214.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A computer-implemented method for generating advertisements, the method comprising:
analyzing at least one web page to determine style information of the at least one web page;
extracting the style information from the at least one web page; and
generating an advertisement based upon the style information extracted from the at least one web page.

2. The method of claim 1, wherein the style information is selected from a group consisting of dominant colors, font style, font size, and color combinations of the at least one web page.

3. The method of claim 1, further comprising filtering the at least one web page to remove non-relevant information or third party content.

4. The method of claim 1, wherein the style information extracted from the at least one web page are dominant colors from the at least one web page of the advertiser, the dominant colors are used for background color, button color and text color of the advertisement.

5. The method of claim 4, wherein the dominant colors are weighted and the dominant colors greater than a predetermined color weight can be used for the background color of the advertisement.

6. The method of claim 5, wherein dominant colors having a higher contrast and brightness difference than a predetermined contrast and brightness difference value with respect to the background color of the advertisement are selected as text colors to be used for the advertisement, the text colors with a greater color saturation level than a predetermined color saturation level are selected to be the colors selected for headline text color for the advertisement and text colors with a lower color saturation level than the predetermined color saturation level are selected to be the colors selected for description text color for the advertisement.

7. The method of claim 4, wherein the dominant color selected for the button color is the color with the highest saturation weight on the advertiser's web page or the color with the highest contrast to the background color chosen for the advertisement and the dominant color selected for button text color for the advertisement is the dominant color having the highest contrast and brightness difference relative to the dominant color of the selected button color.

8. The method of claim 1, wherein font style of the at least one web page is extracted and grouped into a large font group and a small font group, the large font group being any font at or over a predetermined font size and the small font group being any font under the predetermined font size.

9. The method of claim 8, wherein the font most frequently used in the large font group is used for headline text of the advertisement and the font most frequently used in the small font group is used for any other text of the advertisement.

10. The method of claim 1, further comprising storing the advertisement in an advertisement database of an ad server.

11. An apparatus comprising:
a memory for storing an advertiser's web page;
an ad generation system to analyze the advertiser's web page, extract style information from the web page and generate an advertisement based upon the style information extracted from the web page; and
a second memory for storing the advertisements.

12. The apparatus of claim 11, wherein the ad generation system includes an extraction engine for extracting the style information from the advertiser's webpage and an ad generation engine for selecting and incorporating the extracted style information into the advertisement.

13. The apparatus of claim 11, further comprising an advertisement database for storing the advertisements.

14. The apparatus of claim 11, wherein the style information is selected from a group consisting of dominant colors, font style, font size, and color combinations of the at least one web page.

15. The apparatus of claim 11, further comprising filtering the at least one web page to remove non-relevant information or third party content.

16. The apparatus of claim 11, wherein the style information extracted from the at least one web page are dominant colors from the at least one web page of the advertiser, the dominant colors are used for background color, button color and text color of the advertisement.

17. The apparatus of claim 16, wherein the dominant colors are weighted and the heaviest weighted dominant color is used for the background color of the advertisement.

18. The apparatus of claim 17, wherein the dominant color having the highest contrast and brightness difference relative to the dominant color used for the background color is selected for advertisement content text color for the advertisement.

19. The apparatus of claim 16, wherein a dominant color is selected for the button color and another dominant color having the highest contrast and brightness difference relative to the dominant color used for the button color is selected for button text color for the advertisement.

20. The apparatus of claim 11, wherein font style of the at least one web page is extracted and grouped into a large font group and a small font group, the large font group being any font at or over a predetermined font size and the small font group being any font under the predetermined font size.

21. The apparatus of claim 20, wherein the font most frequently used in the large font group is used for headline text of the advertisement and the font most frequently used in the small font group is used for any other text of the advertisement.

22. A computer-readable data storage medium on which is stored programming instructions adapted for execution by one or more processors to:
analyze at least one web page to determine style information of the at least one web page;
extract style information from the at least one web page; and
generate an advertisement based upon the style information extracted from the at least one web page.

23. The medium of claim 22, wherein the style information is selected from a group consisting of dominant colors, font style, font size, and color combinations of the at least one web page.

24. The medium of claim 22, further comprising filtering the at least one web page to remove non-relevant information or third party content.

25. The medium of claim 22, wherein the style information extracted from the at least one web page are dominant colors from the at least one web page of the advertiser, the dominant colors are used for background color, button color and text color of the advertisement.

26. The medium of claim 25, wherein the dominant colors are weighted and the dominant colors greater than a predetermined color weight can be used for the background color of the advertisement.

27. The medium of claim 26, wherein dominant colors having a higher contrast and brightness difference than a predetermined contrast and brightness difference value with respect to the background color of the advertisement are selected as text colors to be used for the advertisement, the text colors with a greater color saturation level than a predetermined color saturation level are selected to be the colors selected for headline text color for the advertisement and text colors with a lower color saturation level than the predetermined color saturation level are selected to be the colors selected for description text color for the advertisement.

28. The medium of claim 25, wherein the dominant color selected for the button color is the color with the highest saturation weight on the advertiser's web page or the color with the highest contrast to the background color chosen for the advertisement and the dominant color selected for button text color for the advertisement is the dominant color having the highest contrast and brightness difference relative to the dominant color of the selected button color.

29. The medium of claim 22, wherein font style of the at least one web page is extracted and grouped into a large font group and a small font group, the large font group being any font at or over a predetermined font size and the small font group being any font under the predetermined font size.

30. The medium of claim 29, wherein the font most frequently used in the large font group is used for headline text of the advertisement and the font most frequently used in the small font group is used for any other text of the advertisement.
